(19) United States
(12) Patent Application Publication
(10) Pub. No.: US 2006/0048106 A1
(43) Pub. Date: Mar. 2, 2006

(54) Link-time profile-based method for reducing run-time image of executables

(75) Inventors: Daniel Citron, Haifa (IL); Gad Haber, Nesher (IL); Roy Levin, Haifa (IL)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 10/928,678

(22) Filed: Aug. 27, 2004

(51) Int. Cl. G06F 9/45

(52) U.S. Cl. 717/136; 717/131

(57) ABSTRACT

An executable program file is produced, which has a reduced run-time image size and improved performance. Profiling information is obtained from an original executable program. Both the original executable code and the profiling information are used to generate the new executable program file. All frozen basic blocks are grouped together and relocated in a separate non-loading module. Each control transfer to and from the relocated code is replaced by an appropriate interrupt. An interrupt mechanism invokes an appropriate handler for loading the relevant code segments from the non-loading module containing the targeted basic blocks. Since the relocated basic blocks are frozen, the time-consuming interrupt mechanism is rarely if ever invoked during run-time, and therefore, has no significant effect on performance.

### BACKGROUND OF THE INVENTION

1. Field of the Invention

This invention relates to computer software programs. More particularly, this invention relates to methods and systems for producing small run-time images of computer software programs.

2. Description of the Related Art

As a consequence of the remarkable developments in computer hardware in recent years, desktop computers and workstations now readily accommodate large executable files and libraries. More recently, however, smaller, resource-constrained platforms have emerged, for example, mobile telephones, personal digital assistants, laboratory instrumentation, smart cards, and set-top boxes. In such devices, the run-time image size of executables and libraries has become an important limiting factor. One known solution is to automatically reduce the size of executables using various compression techniques. However, aggressive compression of executables requires a separate decompression stage before the module can run. Other compression methods, which generate executable files by decompressing the code automatically at run-time, have a small compression ratio and degrade the program's performance. Furthermore, decompression before execution requires even more memory than loading an uncompressed executable.

Hardware based decompression is another known approach. IBM's CodePack™ technique uses dedicated lookup tables to decompress code that is fetched to the L1 ICache. The disadvantages of this technique include a potential penalty that is incurred for every line brought into the cache, and increased hardware costs.

At the other end of the spectrum are schemes that reduce the size of the representation of individual instruction. The Thumb and MIPS16 instruction sets are composed of 16-bit instructions that implement 32-bit architectures. These implementations trade code size for number of registers required for operation.

Virtual memory enables a computer to have a relatively small amount of physical random access memory (RAM), yet emulate a much larger memory. Segments or pages of memory that are not in use are stored on disk. When they are accessed, they are swapped in, and other, unused segments are swapped out. This approach allows the use of relatively small physical memory for executables. However, a severe performance penalty must be paid, due to extensive disk I/O. In addition, some form of mapping between the virtual address and the real address must exist. Usually a map resides in a high cost physical memory, such as a cache memory, in order to improve performance. This preempts a valuable and limited memory resource.

DOS operating systems, as well as older operating systems have employed memory overlays. Overlaying is a method of reducing the memory requirements of a program by allowing different parts of the program to share the same memory space. Only the overlay that is currently executing must be in memory. The others are on disk and are read when they are needed. The approach also involves extensive disk I/O, which penalizes performance.

### REFERENCES

1. Gadi Haber, Ealan A. Henis, and Vadim Eisenberg, “Reliable Post-link Optimizations Based on Partial Information” Proc. Feedback Directed and Dynamic Optimizations 3 Workshop, December 2000.
2. E. A. Henis, G. Haber, M. Klausner and A. Warshavsky. “Feedback Based Post-link Optimization for Large Subsystems.” Second Workshop on Feedback Directed Optimization, pp. 13-20, November 1999.
3. W. J. Schmidt, R. R. Roediger, C. S. Mestad, B. Mendelson, I. Shavitt-Lottem, and V. Bortnikov-Sitnitsky, “Profile-directed restructuring of operating system code”, IBM Systems Journal, 37, No. 2, pp. 270-297, 1998.
4. S. McFarling, “Program Optimization for Instruction Caches”. Proc. Third Intl Conf. on Architectural Support for Programming Languages and Operating Systems, pp. 183-191, April 1989.
5. R. R. Heisch, “Trace-Directed Program Restructuring for AIX Executables”, IBM Journal of Research and Development 38, No. 5, pp. 595-603, September 1994.
6. I. Nahshon and D. Bernstein. “FDPR—A Post-Pass Object Code Optimization Tool”, Proc. Poster Session of the International Conference on Compiler Construction, pp. 97-104, April 1996.
7. K. Pettis and R. Henson, “Profile Guided Code Positioning”, Proc. Conf. on Programming Language Design and Implementation, pp. 16-27, June 1990.
8. A. Srivastava and D. W. Wall, “A practical System for Intermodule Code Optimization at Link-Time”, Journal of Programming Languages, 1, pp 1-18, March 1993.
9. T. Ball and J. R. Larus, “Efficient Path Profiling”. Proc. 29th Annual IEEE/ACM intl. Symp. on Microarchitecture, pp. 46-57, December 1996.
10. J. Fisher and S. Freudenberger, “Predicting Conditional Branch Directions From Previous Runs of a Program”, Proc. Intl. Conf. On Architectural Support for Programming Languages and Operating Systems, October 1992.
11. A. V. Aho, R. Sethi, and J. D. Ullman, “Compilers: Principles, Techniques and Tools”, Reading, Mass. Addison-Wesley, 1988.
12. Larus and Schnarr, “EEL: Machine-Independent Executable Editing”, Proceedings of the 1995 ACM SIGPLAN Conference on Programming Languages Design and Implementation (PLDI), June 1995, pp 291-300.
13. J. Larus and T. Ball, “Rewriting Executable Files to Measure Program Behaviour”, Software Practice & Experience, 24(2):197-218, February 1994.
14. R. Cohn, D. Goodwin and P. G. Lowney, “Optimizing Alpha Executables on Windows NT with Spike, Digital Technical Journal, 9(4): pp 3-20, 1997.
15. A. Srivastava and A. Eustace, “ATOM, a System for Building Customized Program Analysis Tools”, Proceedings of the 1994 ACM SIGPLAN Conference on Programming Languages Design and Implementation (PLDI), June 1994.
16. T. Romer, G. Voelker, D. Lee, A. Wolman, Wong, Levy, B. Chen and Bershad, “Instrumentation and Optimization of Win32/Intel Executables Using Etch”, Proceedings of the USENIX Windows NT Workshop, pp. 1-7, August 1997.
17. G. Haber, M. Klausner, V. Eisenberg, B. Mendelson, M. Gurevich “Optimization Opportunities Created by Global Data Reordering” First International Symposium on Code Generation and Optimization (CGO'2003) San Francisco, Calif., pp. 228-241, March, 2003.
18. J. Cleary and I. Witten, “Data Compression Using Adaptive Coding and Partial String Matching”, IEEE Transactions on Communications, 32(4):396-402, 1984.
19. C. Fraser. E. Myers, and A. Wendt, “Analyzing and Compressing Assembly Code”, ACM SIGPLAN Symposium on Compiler Construction, 19:117-121, 1984.
20. P. Howard and J. Vitter, “Design and Analysis of Fast Text Compression Based on Quasi-Arithmetic Coding”, Data Compression Conference, pages 98-107, 1993.
21. S. Liao, S. Devadas, K. Keutzer, and S. Tijang, “Instruction Selection Using Binate Covering for Code Size Optimization” International Conference on Computer-Aided Design, pages 393-399, 1995.
22. S. Lucco, “Split-Stream Dictionary Program Compression”, Programming Languages Design and Implementation, pages 27-34, 2000.
23. A. Moffat, “Implementing the PPM Data Compression Scheme”, IEEE Transactions on Communications, 38(11):1917-1921, 1990.
24. S. Larin and T. Conte, “Compiler Driven Cached Code Compression Schemes for Embedded ILP Processors, 32nd Annual International Symposium on Microarchitecture (MICRO'32), pages 82-92.
25. C. Lefurgy, E. Piccininni and T. Mudge, “Evaluation of a High Performance Code Compression Method”, 32nd Annual International Symposium on Microarchitecture (MICRO'32), pages 93-102.
26. S. Debray and W. S. Evans “Cold Code Decompression at Runtime”, Journal of Communications of the ACM, pp. 55-60, Vol. 46, No. 8, August 2003.
27. U.S. Pat. No. 6,516,305—“Automatic inference of models for statistical code compression”.
28. U.S. Pat. No. 6,317,867—“Method and system for clustering instructions within executable code for compression”.
29. A. Lempel and J. Ziv, “A Universal Algorithm for Sequential Data Compression”, IEEE Trans. on Inform. Theory, vol. IT-23, no. 3, pp. 337-349, May 1977.
30. M. Kozuch and A. Wolfe, “Compression of Embedded System Programs, Proc. of ICCD '94, pp. 270-277, 1994.
31. www.winzip.com, The Archive Utility for Windows.
32. www.gzip.org, The GZIP home page.
33. A. Wolfe and A. Chanin, “Executing Compressed Programs on an Embedded RISC Architecture”, Proc. of the 25th International Symposium on Microarchitecture, pp. 81-91, December 1992.
34. J. Hoogerbrugge et al, “A Code Compression System Based on Pipelined Interpreters”, Software Practice and Experience 29, 1, pp. 1005-1023, January, 1995.
35. C. Lefurgy, E. Piccininni, T. Mudge, “Reducing Code Size with Runtime Decompression”, Proc. of the HPCA 2000 Conference, pp. 218-227, January, 2000.
36 C. Lee, M. Potkonjak, and W. H. Mangione-Smith, Mediabench: A Tool for Evaluating and Synthesizing Multimedia and Communications Systems, in Proceedings of the 32^{nd} Annual International Symposium on Microarchitecture, pages 330-335, December, 1997.

### SUMMARY OF THE INVENTION

According to a disclosed embodiment of the invention methods and systems are provided for converting an executable program file into a smaller run-time image. Profiling information is first obtained from the original executable program. Both the original executable code and the profiling information are used to generate the new executable program file. Rarely or never accessed regions are identified, and relocated to a non-loaded segment, or to a separate file. Optionally, any portion of the regions may be stored in a compressed format. In the case of memory constrained devices, the rarely accessed regions may even be stored in an entirely different memory space, for example non-volatile memory. Each control transfer to and from the relocated region is replaced by an appropriate interrupt. An interrupt or trapping mechanism invokes an appropriate handler for loading the relevant regions from the non-loaded module. Since the relocated regions are frozen, the time-consuming interrupt or trapping mechanism is rarely invoked during run-time, and therefore, does not degrade performance.

The relocated regions are loaded on demand during run-time, or alternatively, loaded together with non-relocated code into a secondary memory device. In addition to the benefits of loading a smaller run-time image, an additional performance gain derives from improvement in its code and data locality, as compared with the original executable program file.

Application of the instant invention generates a smaller image of the executable program than the above-noted compression techniques. Removal of rarely used regions is accomplished automatically. This is advantageous, compared with conventional overlaying, which requires extensive programmer intervention. Because executables now take up less disk space, they may often be able to run upon demand without requiring decompression.

In a multi-processed and multi-threaded environment, executables with smaller run-time images require less paging space in the OS virtual table map, sparing conventional memory for other currently running tasks. In the case of kernel programs, more conventional memory is made available for user-mode processes, thereby decreasing the number of page faults and increasing total system performance.

Experimentally, image size reductions ranging form 59% to 79% have been achieved.

The invention provides a method for producing a run-time image of a computer program for execution thereof by a target computing device, which is carried out by identifying frozen regions in the program that are never accessed during run-time, and identifying non-frozen regions in the program that are accessed during run-time, identifying referencing instructions of the non-frozen regions that cause respective ones of the frozen regions to be referenced by the program, placing the frozen regions into a non-loading module, and placing the non-frozen regions into a loading module that is executable by the target computing device. The method is further carried out by modifying the referencing instructions, so that execution of the modified referencing instructions in the loading module by the target computing device causes the respective ones of the frozen regions to be transferred from the non-loading module into a memory that is accessible by the target computing device.

In an aspect of the method, the frozen and non-frozen regions are identified by profiling the dynamic behavior of the program.

According to one aspect of the method, placing the frozen regions in the non-loading module includes determining target offsets of the frozen regions in the non-loading module.

According to another aspect of the method, the frozen regions comprise executable code.

According to a further aspect of the method, the frozen regions comprise static data.

In yet another aspect of the method, the modified referencing instructions are invalid instructions, which are modified by providing an error handling routine that is invoked in the target computing device responsively to the invalid instructions. The error handling routine is operative to transfer one of the frozen regions from the non-loading module into the memory.

In still another aspect of the method, a loading routine is provided, which is operative to allocate the memory dynamically for storage of the frozen regions that are transferred therein.

According to one aspect of the method, the loading routine operates speculatively to transfer the frozen regions from the non-loading module to the memory prior to execution of the modified referencing instructions.

Another aspect of the method the steps of identifying and placing the frozen regions, and modifying the instructions are further performed with respect to cold regions in the program.

The invention provides a computer software product, including a computer-readable medium in which instructions are stored, which instructions, when read by a computer, cause the computer to perform a method for producing a run-time image of a computer program for execution thereof by a target computing device, which is carried out by identifying frozen regions in the program that are never accessed during run-time, and identifying non-frozen regions in the program that are accessed during run-time, identifying referencing instructions of the non-frozen regions that cause respective ones of the frozen regions to be referenced by the program, placing the frozen regions into a non-loading module, and placing the non-frozen regions into a loading module that is executable by the target computing device. The method is further carried out by modifying the referencing instructions, so that execution of the modified referencing instructions in the loading module by the target computing device causes the respective ones of the frozen regions to be transferred from the non-loading module into a memory that is accessible by the target computing device.

The invention provides a development system for producing a run-time image of a computer program for execution thereof by a target computing device, including a processor operative for identifying frozen regions in the program that are never accessed during run-time thereof, and identifying non-frozen regions in the program that are accessed during run-time, The processor is operative for identifying referencing instructions of the non-frozen regions that cause respective ones of the frozen regions to be referenced by the program, placing the frozen regions into a non-loading module, placing the non-frozen regions into a loading module that is executable by the target computing device, and modifying the referencing instructions, so that execution of the modified referencing instructions in the loading module by the target computing device causes the respective ones of the frozen regions to be transferred from the non-loading module into a memory that is accessible by the target computing device.

According to an aspect of the development system, the processor is further adapted to identify cold regions in the program, place the cold regions in the non-loading module, and modify instructions of the loading module with respect to the cold regions to produce additional modified instructions. These additional modified instructions, when executed by the target computing device, cause respective ones of the cold regions to be transferred from the non-loading module into the memory of the target computing device.

### BRIEF DESCRIPTION OF THE DRAWINGS

For a better understanding of the present invention, reference is made to the detailed description of the invention, by way of example, which is to be read in conjunction with the following drawings, wherein like elements are given like reference numerals, and wherein:

FIG. 1 is a schematic diagram of a system, which is constructed and operative according to a disclosed embodiment of the invention;

FIG. 2 is a flow chart illustrating a method of reducing storage space for executable code in accordance with a disclosed embodiment of the invention;

FIG. 3 is a flow chart illustrating the operation of a loading subroutine for use in the method shown in FIG. 2, in accordance with a disclosed embodiment of the invention;

FIG. 4 is a diagram illustrating a program code layout, which has been modified according to the method shown in FIG. 2, in accordance with a disclosed embodiment of the invention;

FIG. 5 is a diagram illustrating an exemplary function having frozen code therein, prior to code relocation in accordance with a disclosed embodiment of the invention;

FIG. 6 is a diagram illustrating the function shown in FIG. 5, in which frozen code has been relocated to a separate, non-loadable area in accordance with a disclosed embodiment of the invention;

FIG. 7 is a diagram illustrating the function shown in FIG. 5 subsequent to code relocation in accordance with a disclosed embodiment of the invention;

FIG. 8 is a flow diagram of a method of reducing storage space for static data in a program file in accordance with a disclosed embodiment of the invention;

FIG. 9 is a flow chart illustrating the operation of a loading subroutine for frozen data in accordance with a disclosed embodiment of the invention;

FIG. 10 displays graphs showing the percentages of frozen code and data in the CPU2000 suites, as determined in accordance with a disclosed embodiment of the invention;

FIG. 11 displays graphs showing the percentages of frozen code and data in different data sets of CPU2000 suites;

FIG. 12 displays a graph showing the proportions of frozen code and data in the Mediabench suite, in accordance with a disclosed embodiment of the invention;

FIG. 13 displays graphs comparing the proportions of frozen code and data between the training and reference data sets of CINT2000 and CFP2000 suites of the CPU2000 series; in accordance with a disclosed embodiment of the invention; and

FIG. 14, displays a graph comparing the proportions of frozen code and data in the training and reference data sets of the Mediabench suite, in accordance with a disclosed embodiment of the invention.

### DETAILED DESCRIPTION OF THE INVENTION

In the following description, numerous specific details are set forth in order to provide a thorough understanding of the present invention. It will be apparent to one skilled in the art, however, that the present invention may be practiced without these specific details. In other instances, well-known circuits, control logic, and the details of computer program instructions for conventional algorithms and processes have not been shown in detail, in order not to unnecessarily obscure the present invention.

Software programming code, which embodies aspects of the present invention, is typically maintained in permanent storage, such as a computer readable medium. In a client-server environment, such software programming code may be stored on a client or a server. The software programming code may be embodied on a variety of known media for use with a data processing system. This includes, but is not limited to, magnetic and optical storage devices such as disk drives, magnetic tape, compact discs (CD's), digital video discs (DVD's), and computer instruction signals embodied in a transmission medium with or without a carrier wave upon which the signals are modulated. For example, the transmission medium may include a communications network, such as the Internet. In addition, while the invention may be embodied in computer software, the functions necessary to implement the invention may alternatively be embodied in part or in whole using hardware components such as application-specific integrated circuits or other hardware, or some combination of hardware components and software.

Definitions.

The meanings of certain terminology used herein follow:

The term “region” is used generally herein to refer to an area, block, or segment containing one or more of the following: executable code, static data, and data elements. Certain context-specific qualifications of the term region are set forth hereinbelow.

A hot region refers to a region that is frequently executed or referenced at run-time when run on a representative trace.

A cold region refers to a region that is rarely executed or referenced at run-time when run on a representative trace.

A frozen region refers to a region that is never executed or accessed at run-time when run on a representative trace.

A thawed region refers to a region that was originally frozen but was accessed at run-time.

A call instruction is a control transfer instruction, or set of instructions, that perform two operations: saving a return address, and branching to a given target location.

System Overview.

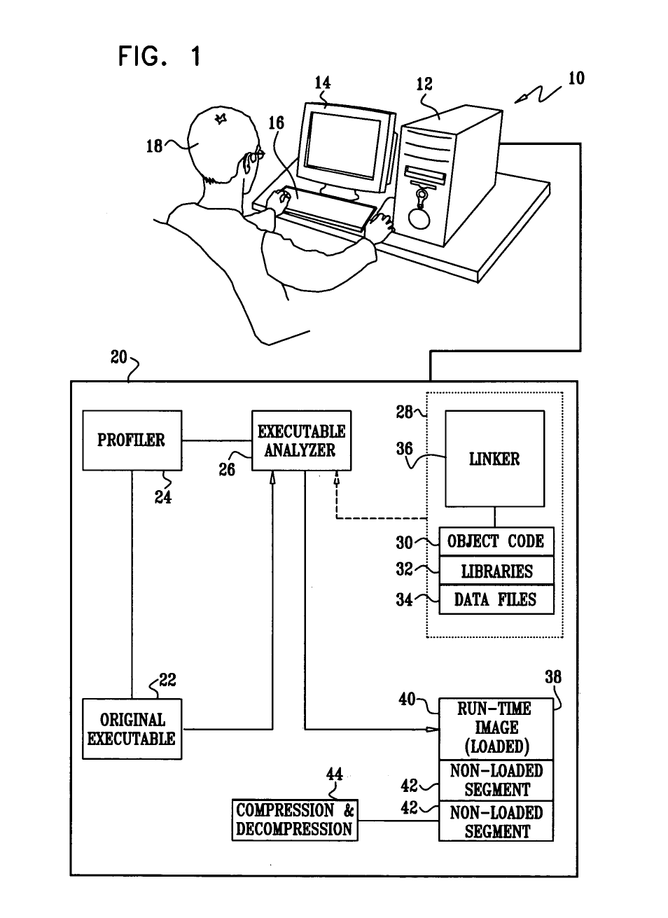

Turning now to the drawings, reference is initially made to FIG. 1, which is a schematic diagram of a system 10 for producing a run-time image of a computer program that is constructed and operative according to a disclosed embodiment of the invention. The system 10 can be any type of computer system. It includes a computing device 12, such as a personal computer or workstation. The system 10 can be a standalone system, or may be a component of a networked environment. Typically, a client interface to the system 10 is realized by a monitor 14 and an input device, which is typically a keyboard 16 for use by an operator 18.

Various system and application software programs execute in a memory of the computing device 12, indicated by a memory area 20. The memory area 20 is merely representative, and many types of memory organization known in the art are suitable for use in the computing device 12.

Included in the memory area 20 is an original executable 22, which is to be converted into a small run-time image according to the invention.

The memory area 20 includes a profiler 24 for gathering profile information on a representative workload for the executable. The profiler 24 collects information about the dynamic behavior of the original executable 22. Typically, the original executable 22 is evaluated while running one or more benchmarks believed to be representative of the way the program would be used in practice. A report produced by the profiler 24 provides sufficient information so that it is possible to determine whether any instruction in the code has been executed, and its execution frequency. In addition, it is possible to determine whether any given variable or data has been referenced, and how often.

Profilers are well-known in the art. For example, a profiler run under the AS/400 architecture is described in Reference 3, which is herein incorporated by reference.

Responsively to the information developed by the profiler 24, an executable analyzer 26 separates the original executable 22 into its constituent functions, basic code and data blocks, classifies them as frozen, cold, or hot, and adjusts all relevant control transfer instructions needed for cooperation among the constituents. In some embodiments, the executable analyzer 26 is a post-link analyzer.

In Reference 1, which is incorporated herein by reference, Haber et al. describe an approach for dealing with difficulties posed by the fact that static post-link optimization tools are forced to operate on low-level executable instructions. First, the program to be analyzed or optimized is disassembled into basic blocks, by incrementally following all control flow paths that can be resolved in the program. The basic blocks are marked as either code, data or unclassified. The last category is a default, when it is not possible to fully analyze the blocks. Code blocks are further flagged according to their control flow properties. Partially analyzed areas of the program are delimited, so as to contain the unclassified blocks, while relieving the rest of the program of the limitations that these blocks impose on optimization. The partially analyzed areas are chosen so that even when they cannot be internally optimized, they can still be repositioned safely en bloc to allow reordering and optimization of the code as a whole.

The executable analyzer 26 can also be the post-link analyzer that is disclosed in commonly assigned U.S. Patent Application Publication No. 2004/0019884, entitled Eliminating Cold Register Store/Restores within Hot Function Prolog/Epilogs, which is incorporated herein by reference. Employing a post-link analyzer as the executable analyzer 26 has the advantage that source code is not required for the analysis, allowing legacy code to be processed where no source code is available.

Alternatively, the executable analyzer 26 can be a link-time executable analyzer. In this case a group 28, consisting of unlinked object code 30, libraries 32, and data files 34 are linked by a linker 36. The executable analyzer 26 cooperates with the linker 36 at link time to link the object code 30, libraries 32, and data files 34 into a run-time image 38. In embodiments in which the executable analyzer 26 is a post-link analyzer, the group 28 can be omitted.

In any case, the executable analyzer 26 produces the run-time image 38, which consists of a loaded segment 40, which, in a target computing device (not shown), is initially loaded into execution memory, and one or more non-loaded segments 42, which are loaded into memory on demand.

Various other link-time and post-link analyzers are known in the art, for example from References 1-16. A post-link profile-based method of static data placement in executables is disclosed in Reference 17, which is herein incorporated by reference.

Optionally, the memory area 20 may include a compression and decompression utility 44 that can compress and decompress code and data efficiently. Many data compression and decompression techniques are suitable for the utility 44. Examples are given in References 18-25, 29, and 30. In some embodiments, the utility 44 may be associated with the run-time image 38 for execution on the target computing device (not shown).

Executable Code Reduction.

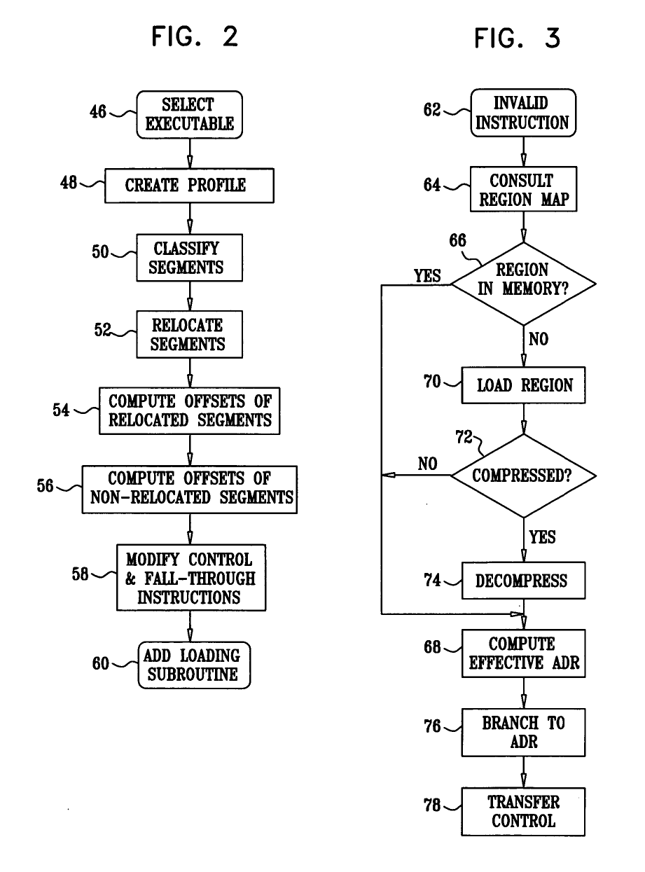

Reference is now made to FIG. 2, which is a flow chart illustrating a method of producing a small run-time image in accordance with a disclosed embodiment of the invention. The method begins at initial step 46. A program is chosen for processing. The result of the method is a target executable file comprising a run-time image that is smaller than the run-time image of the chosen program.

Next, at step 48, the program selected in initial step 46 is run, and evaluated by a profiler, as described above. A profile of the program is prepared.

Next, at step 50, code segments of the program are classified as hot, cold and frozen. The criteria for the classification are dependent both on the size of the executable, and the limitations of the computing device on which the executable is to be run. Any instruction that is not executed is marked as frozen. A metric for the classification of cold regions generally involves a tradeoff. If too many segments are classified as cold or frozen, then a performance penalty must be paid whenever such segments are actually loaded into memory. On the other hand, failure to classify such segments as frozen increases the size of the ultimate run-time image. An optimum is application dependent. In the current embodiment, it has been found suitable to mark a code region as cold when the execution count of the region is less 10% of the average instruction count.

Next, at step 52, all the frozen segments that were identified in step 50 are either relocated to a non-loaded area of the output file, or stored in a separate file. Optionally, the frozen code can be maintained in a compressed form. As frozen segments are seldom, if ever accessed, there is a minimal penalty for decompressing them. It is somewhat less desirable to compress cold segments, however, as they are occasionally accessed, and a penalty must be paid for the decompression step. The decision to compress different segments or not can be made automatically, according to predetermined criteria, based on the profile generated in step 48 and the characteristics of the target computing device.

AS part of the relocation process, it is desirable to reorder the program code, based on the profiling data. For example, consider the pseudo-assembly instructions, which are shown in Listing 1 prior to code reordering. In the following figures, hot code is indicated by the symbol “*”. Frozen code is indicated by the symbol “#”.

| | | Listing 1 |
|---|---|---|
| | compare r1, r2 | * |
| | jump-false L1 | * |
| | (Frozen Then Part) | # |
| | ... | # |
| L1: | (Hot Continue Part) | * |

Following reordering, the code in Listing 1 has the form shown in Listing 2. In the reordered code, the conditions of the conditional jump instruction are reversed. As a result, the hot code is contiguous, and the frozen code is isolated from the jump instruction, being placed farther away in the program. This form of code reordering has the benefit of reducing instruction cache misses and the number of executions per branch in the code.

| | | Listing 2 |
|---|---|---|
| | compare r1, r2 | * |
| | jump-true L1 | * |
| L1: | (Hot Continue Part) | * |
| | ... | * |
| L2: | (Frozen Then Part) | # |
| | ... | # |
| | Jump L1 | # |

Note that in order to maintain consistency with the control flow in Listing 1, an additional unconditional jump instruction to the label L1 was added at the end of the relocated frozen code part.

Next, at step 54, control flow instructions, and fall-through instructions that cause control to transfer into and out of the frozen segments and any relocated cold segments are identified. Target offsets for each of these instructions are computed. Preferably, the target offsets in relocated areas are calculated from the beginning of their respective memory segments or files.

Next, at step 56 target offsets of control flow instructions, and fall-through instructions in non-relocated segments are calculated, measured from the beginning of the original program file or from the beginning of their respective segments.

Next, at step 58, the control flow instructions, and fall-through instructions in the relocated segments that were identified in step 54 are modified, such that execution of the instructions now result in the generation of an interrupt or an exception. The modifications can be accomplished by replacing either control flow instructions or fall-through instructions with invalid instructions. At run-time, should a relocated segment be referenced, there would be an attempt to execute the invalid instructions. An interrupt or exception would then be generated, and an error handling routine automatically invoked, resulting in loading and access of the relocated segment. The error handling routine normally receives the invalid instruction, or a reference to the invalid instruction. Listing 3 is the result of replacing of jump instructions by invalid instructions in the example of Listing 2.

| | | Listing 3 |
|---|---|---|
| | compare r1, r2 | * |
| | jump-true L2I | * |
| L1: | (Hot Continue Part) | * |
| | ... | * |
| L2I | Invalid Opcode (containing the offset of L2) | |
| L2: | (Frozen Then Part) | # |
| | ... | # |
| | invalid Opcode (containing the offset of L1) | |

Branches between the relocated and non-relocated segments are accomplished using above-described exception handling mechanism. The added invalid instructions consist of an invalid opcode, the offset of the target instruction in corresponding relocated and non-relocated segment, and a flag indicating the status of the target segment (relocated or non-relocated) containing the target instruction. This flag can be masked into the invalid opcode itself. In any case, it is essential that when reading the invalid instruction, the loading module can easily determine the target offset in the relevant segment into which the branch is taken, preferably without recourse to a map. The exact implementation is, of course machine specific, but can be readily accomplished by those skilled in the art, using the instruction sets of CPU's that are used today.

The relocated segment is divided into regions. For this purpose, a region is a sequence of instructions that are loaded on demand as a whole, and in which control flow instructions that remain within the sequence can be left as is and those that branch out of the sequence are modified, as is explained hereinbelow.

A simple method for creating regions is defining each basic block as a region, however much better definitions can be made. For example, one may identify code areas that will most likely be executed together, and define them as regions. While all the instructions within a basic block are executed together, due to the definition of a basic block, the granularity is sufficient but not always optimal. The regions are loaded on demand by the loading module as a whole. Each region is specified by its starting offset in the relocated segment and its size.

The relocated segment also includes a “region map”, which is a data structure that supports quick mapping from offsets in the relocated segments to appropriate regions. Using this map, and given an offset in the relocated segment, the loading module can quickly identify the region's starting point and size. When a region is defined as a basic block, mapping is trivial. Nonetheless, a mapping is required to find the regions.

A direct unconditional branch to or from a relocated segment is replaced by an invalid instruction as described above.

A conditional branch instruction into or out of a relocated code segment is modified to branch to an intermediate location consisting of an invalid instruction, followed by the appropriate target offset.

A conditional branch instruction, which falls through or out of a relocated segment, has its logical condition reversed, that is the target and fall through are effectively exchanged. The instruction is then further modified as described above. Alternatively, an invalid instruction is inserted immediately after the conditional branch, followed by the appropriate target offset.

Three different types of indirect branch instructions are recognized, and are handled as follows:

(1) Branch tables—each relocated target is replaced by an invalid instruction as described above.

(2) Function epilogs—each call instruction that has a relocated return point (the instruction after the call), which is replaced by an invalid instruction as described above.

(3) Indirect function call—If the function's prolog has been relocated, the prolog is replaced by an invalid instruction as described above.

A non-branch instruction that falls through to a relocated segment has an invalid instruction inserted immediately thereafter, as described above.

Next, at final step 60, a loading subroutine is added to the target executable file. Alternatively, the loading subroutine may be placed in a linkable module. This module is then linked, either statically or dynamically, to the target executable file. During run-time, the loading subroutine is capable of loading the appropriate region from the relocated region into a new area of memory, where it is referred to as “promoted code”. The loading subroutine also loads the code for intercepting the trap generated by the invalid instructions that were inserted in step 58. In some embodiments, this interrupt handler is inserted at the entry point to replace the corresponding default interrupt handler for handling exceptions in the manner described above.

Reference is now made to FIG. 3, which is a flow chart illustrating in further detail certain aspects of the operation of a loading subroutine that, in accordance with a disclosed embodiment of the invention. The procedure begins at initial step 62, where an invalid instruction is encountered.

Next, at step 64, a region map is accessed in order to locate the region that contains the offset coded in the invalid instruction. When the region is defined as a basic block, the map is trivial by definition.

Control now proceeds to decision step 66, where, it is determined whether the region is already loaded or not, based on entries in a dynamic marking map, which is maintained at runtime, and grows on demand, for example in the rare event that a frozen region is accessed. This runtime map is to be distinguished from the region map described above. The latter is static, and is not altered by the loading routine.

If the determination at decision step 66 is affirmative, then control proceeds to step 68, which is described below.

If the determination at decision step 66 is negative, then control proceeds to step 70. Memory is dynamically allocated to hold the region that was identified in step 64. Once the region has been loaded into this memory, the code occupying the memory is considered to be promoted code. The dynamic marking map is now modified so as to mark the region as loaded.

In the event that there is insufficient free memory to accommodate the region, then memory occupied by other regions are freed, preferably using a least recently used (LRU) discipline.

Control now proceeds to decision step 72, where it is determined if the region that was loaded in step 70 was stored in a compressed format, and now needs to be decompressed.

If the determination at decision step 72 is negative, then control proceeds directly to step 68.

If the determination at decision step 72 is affirmative, then control proceeds step 74. The region is decompressed using any of the above-noted methods.

At step 68 the effective address of the target is determined, using the target offset that was embedded in the invalid instruction, added to the base loading address of the relevant block or segment minus the region's offset in the relocated segment.

Next, at step 76 a branch is taken to the address that was calculated in step 68.

Next, in final step 78, control is transferred to the calculated address, and the loading subroutine terminates.

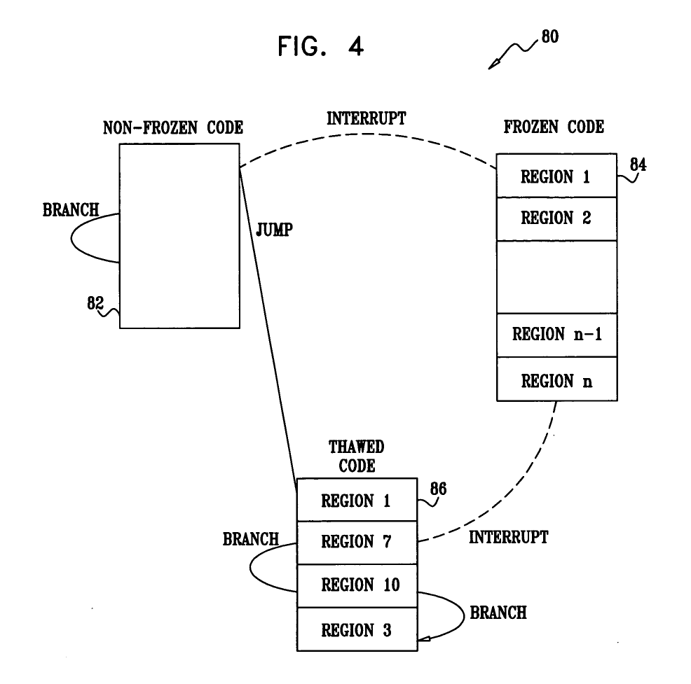

Reference is now made to FIG. 4, which is a diagram illustrating a program code layout 80, which has been modified according to the method disclosed with reference to FIG. 2, in accordance with a disclosed embodiment of the invention. The program code layout consists of three main areas: a non-frozen area 82, a frozen area 84 and a thawed area 86.

The non-frozen area 82 is laid out sequentially in main memory. The frozen area 84 is laid out sequentially on disk, or any suitable secondary memory device. This area is divided into regions. In the event of a reference to a frozen instruction, the entire region containing the referenced instruction is loaded into the thawed area 86.

As described above, all control transfers between regions are replaced by corresponding illegal instructions, in order to enable the loading subroutine to handle them at run-time. Control transfers within a scope of a region do not need to be changed when loaded by the loading subroutine.

Finally, the thawed area 86 consists of various thawed code regions, which are allocated in memory at run-time. The thawed code regions are not necessarily successive. Control transfers between thawed and non-frozen code areas are updated to enable the use of direct or indirect branches. Control transfers between thawed or non-frozen to frozen code areas continue to use the above-described interrupt mechanism triggered by the illegal instructions.

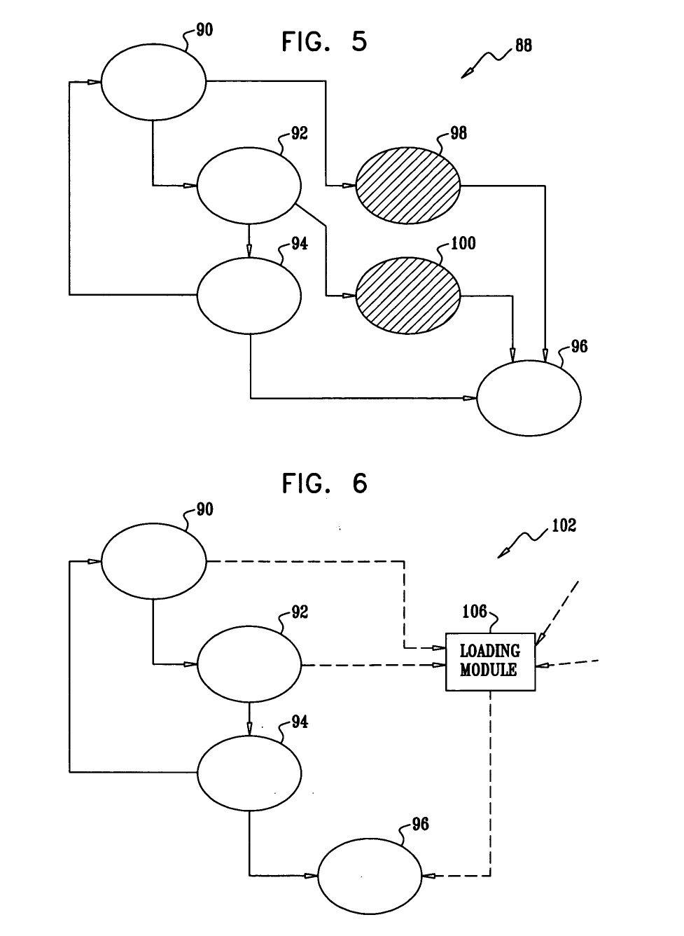

Reference is now made to FIG. 5, which is a diagram illustrating an exemplary function 88 having frozen code therein, prior to relocation of the code in accordance with a disclosed embodiment of the invention. Circles represent basic blocks, and arrows represent control flow between the basic blocks. The function 88 consists of four hot basic blocks 90, 92, 94, 96, and two consecutive frozen basic blocks 98, 100. Frozen blocks are shown as circles having a hatched pattern.

Reference is now made to FIG. 6, which is a diagram, which illustrates the function 88 (FIG. 5) in a new configuration, now referenced as function 102. The frozen code, no longer visible, has been relocated to a separate, non-loadable area. Each control transfer to them from the other basic blocks is replaced with an illegal instruction, containing the offset target of the callee basic block within the area to which it was relocated. The loading subroutine, which includes the code for intercepting the trap created when trying to execute the illegal opcodes, is placed in a different location of the non-frozen code area. Dashed lines represent control transfers between loaded frozen code and non-frozen code via the above-described interrupt mechanism.

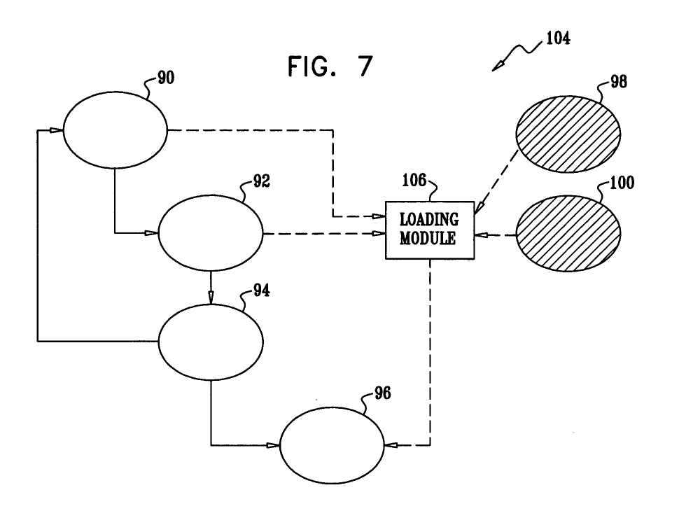

Reference is now made to FIG. 7, which illustrates the function 88 (FIG. 5) in still another configuration, now referenced as function 104, at runtime after thawing of the frozen code blocks 98, 100, in accordance with a disclosed embodiment of the invention. The blocks 98, 100 are now located in a separate section (or file), and each control transfer to them from the other basic blocks in the function has been replaced by a corresponding invalid instruction followed by the target offset of the called basic block within the area to which it was relocated. A loading module 106 includes code for intercepting a trap created when attempting to execute the invalid instructions, as explained above in the discussion of FIG. 2 and FIG. 3. When invoked at run-time, the loading module 106 decompresses the blocks 98, 100 if needed, loads them into a dynamically allocated memory area, and transfers control using their respective target offsets added to the run-time address of the section in which they now reside, and modifies the invalid instructions as described above. Dashed lines in FIG. 7 again represent control transfers between the loaded frozen and the non-frozen code via the interrupt mechanism.

Static Data Reduction.

Reduction of static data in a program file can be done in two ways:

If code reduction has already been performed as disclosed hereinabove, upon access to a relocated region all the frozen data elements accessed by execution of promoted code of the region will be promoted as well. Memory for the data is dynamically allocated and the contents of the relocated data elements will be copied to it, optionally decompressed if compressed. To implement this, specialized relocation information is assembled during classification and relocation (FIG. 2) for use by the loading module, and associated with the instructions that access the relocated data elements. When the relocated data is promoted, access to the data elements will be fixed by the loading module, according to the address that was dynamically given to these data elements.

The second method can be used with or without implementation of code reduction as described above. It is similar to the code reduction method described above. All frozen data elements that are not referenced in a representative trace are relocated, typically grouped together, and then placed in a separate section or file. Each load instruction of the relocated data elements is then replaced by invalid instructions, which are coded differently than those used in the code reduction method. In the case of certain types of data addresses, i.e., compilation section (csect) addresses, the invalid instruction must also encode the target register into which to load the data element address. The invalid instructions trigger a trap mechanism that causes the referenced data element to be loaded into memory and its address to be loaded into the appropriate target register.

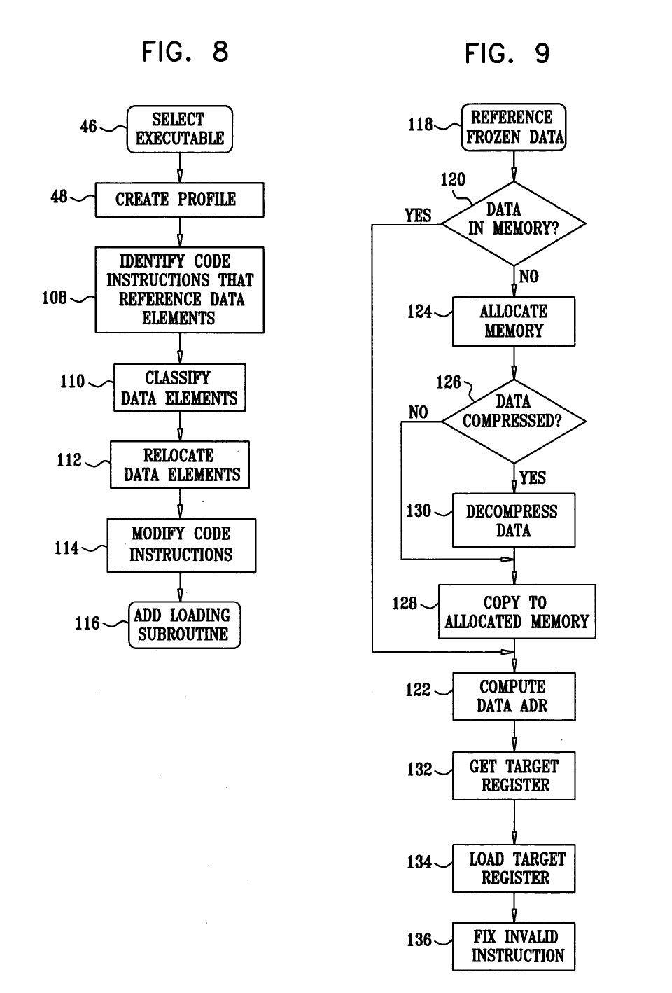

Reference is now made to FIG. 8, which is a flow diagram of a method of reducing storage space for static data in a program file in accordance with a disclosed embodiment of the invention. The method begins with initial step 46 followed immediately by step 48. These steps are performed in the same manner as described above with respect to FIG. 2. The details are not repeated in the interest of brevity.

Next, at step 108, code instructions that reference static data elements are identified. These instructions need to be updated during data repositioning. In normal operation, these instructions are updated by a linker, once global data elements have been placed in the program file. As a result, these instructions already have appropriate linker relocation information attached to them that enables identification of the instructions. The technique of global data placement is known from the above-noted Reference 17.

Next, at step 110, profiling information obtained in step 48 is used to classify data elements within the static data area, and in particular to identify all frozen data elements. Optionally, at this point the profiling information may aid classification of the code instructions in step 50 (FIG. 2). This information can help determine whether the code instructions that reference a particular data variable are all frozen.

Next, at step 112, the frozen data elements that were identified in step 110 are relocated to a non-loading section area of the target executable file, or alternatively, into a separate file. Optionally, the relocated frozen data may be maintained in a compressed form.

Next, at step 114, each code instruction referring to a frozen data element is replaced by an invalid opcode instruction, followed by the offset of the frozen data element in the non-loading section to which it was relocated in step 112. During run-time, in the unlikely case that the frozen data is referenced, an invalid instruction interrupt will be thrown by the system. A loading subroutine is then automatically invoked by catching the trap thrown by the invalid instructions.

Next, at final step 116, a loading subroutine is added to the target executable file. Alternatively, the loading subroutine can be placed in a linkable module and linked statically or dynamically to the executable file.

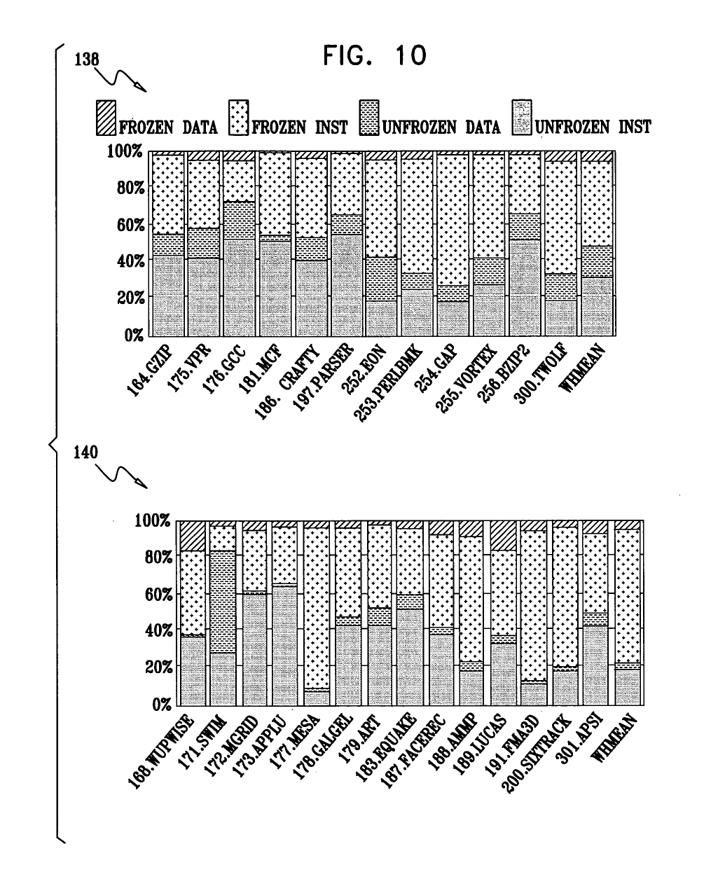

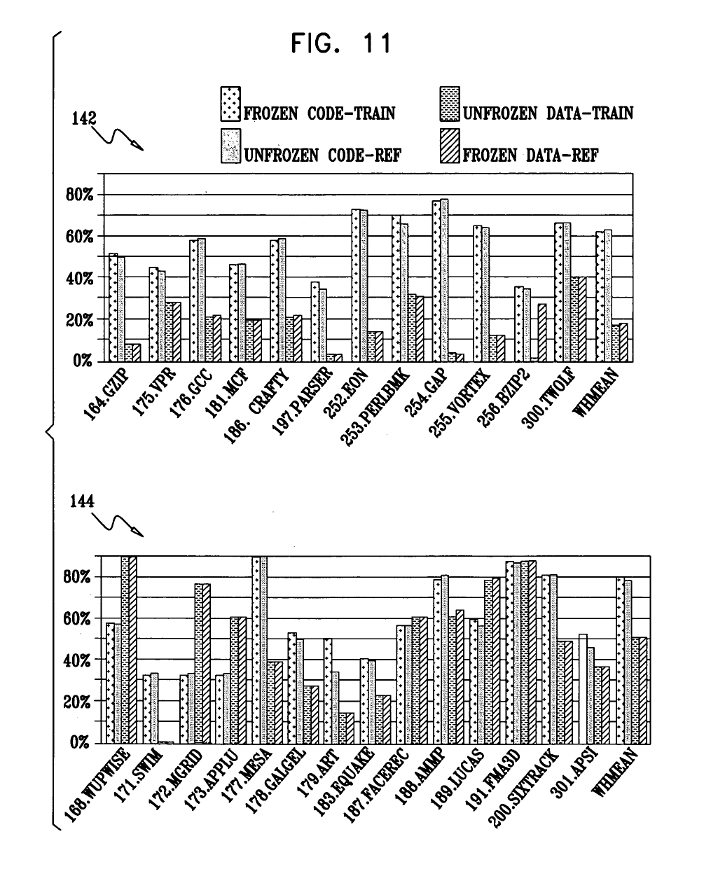

Reference is now made to FIG. 9, which is a flow chart illustrating the operation of a loading subroutine for frozen data in accordance with a disclosed embodiment of the invention. During run-time on a target computing device, the loading subroutine is capable of loading the entire frozen data area or, preferably, relevant parts thereof. Good candidates for such parts are individual data elements. The loading subroutine includes code for intercepting the trap generated by the invalid instructions that were placed in the code in step 114 (FIG. 8).

The loading subroutine is invoked at run-time in initial step 118, when frozen data is referenced.

Control now proceeds to decision step 120, where it is determined whether the frozen data that was referenced in initial step 118 has already been loaded into memory.

If the determination at decision step 120 is affirmative, then control proceeds directly to step 122, which is described below.

If the determination at decision step 120 is negative, then control proceeds to step 124. Here memory is dynamically allocated for the frozen data element.

Control now proceeds to decision step 126, where it is determined if the data loaded in step 124 is stored in a compressed format. If the determination at decision step 126 is negative, then control proceeds to step 128, which is described below.

If the determination at decision step 126 is affirmative, then control proceeds to step 130, where the compressed data is decompressed.

Next, at step 128, the contents of the data relocated data element is copied to the allocated memory.

Next, at step 122 the address in memory of the frozen data elements is obtained by adding the base address of the loaded frozen data area to the target offset that was embedded in the code in step 114 (FIG. 8).

Next, at step 132, The loading subroutine extracts the target register from the invalid instruction.

Then, at step 134 the address of the promoted data element (the address given to the allocated memory) is loaded into the target register that was identified in step 132.

Control now proceeds to final step 136. The invalid instruction is modified in order to access the newly allocated data elements. If a single instruction is insufficient to load the address of the promoted data element into the required register, then a branch to a dynamically created stub is created, and this stub, which will contain a few instructions, will load the address of the promoted data elements into the appropriate register, and return back to its caller. Cases requiring the creation of such stubs are rare, as they needed, at most, when frozen data is accessed. Thus, the number of such stubs will most likely be insignificant.

### Alternate Embodiment 1

Referring again to FIG. 2 and FIG. 8, step 52 (FIG. 2) and step 112 (FIG. 8) may be modified to relocate cold segments and data. However, in the case of relocating cold code to a non-loading section, the trapping mechanism described above, which results in branching between the original code and the relocated code, may cause significant performance degradation. In order to reduce the associated performance overhead, it is recommended that the loading module, after having loaded the appropriate relocated area, modify the triggering invalid instruction so as to access the promoted relocated area directly. If a single instruction is insufficient to access the target, the modified instruction can either call an access stub that references a map that associates calling addresses to accessed targets. Alternatively, a branch can be taken to a dynamically created trampoline for each instruction, which enables the desired access.

### Alternate Embodiment 2

The loading subroutine operates as described above, but is now activated by a separate process or thread. Advantageously, the system can now speculatively load the relocated cold code or data ahead of time, thus preventing the program from waiting until the relevant code or data is loaded into memory when actually needed.

### EXAMPLE 1

In the following example, the inventive technique was applied using a post-link optimization tool known as called feedback directed program restructuring (FDPR). Details of this tool are described in References 1 and 2. FDPR is part of the IBM AIX® operating system for pSeries® servers. FDPR was also used to collect the profile information for the optimizations presented below. Two benchmark suites, CINT2000 and CFP2000 were analyzed to show the percentage of frozen code and data they possess. These two CPU2000® suites are described in Reference 33. They are primarily used to measure workstation performance, but were actually intended by their creator, the Standard Performance Evaluation Council (SPEC®), to run on a broad range of hardware. They are intended to provide a comparative measure of compute-intensive performance across the widest practical range of hardware, including limited resource devices.

It is believed that the types of applications presented in the CPU2000 suites will migrate to limited resource devices. Therefore, it was chosen to analyze 32-bit, rather than 64-bit executables.

The C/C++ benchmarks were compiled on a Power4 running AIX version 5.1 using the IBM compiler x1c v6.0 with the flags:—O3. The Fortran benchmarks were compiled using the x1f v8.1 compiler with the flags:—O3.

The profiles were taken using the suite's training input set two.

Reference is now made to FIG. 10, in which two graphs show the percentages of frozen code and data in the CPU2000 suites, as determined in accordance with a disclosed embodiment of the invention. Results for the CINT2000 suite are shown in graph 138. Results for the CFP2000 suite are shown in graph 140. The results show that an average (weighted harmonic mean) of 64/80% of the code and 19/52% of the data is frozen. This results in executables, which are 58/79% smaller than the originals.

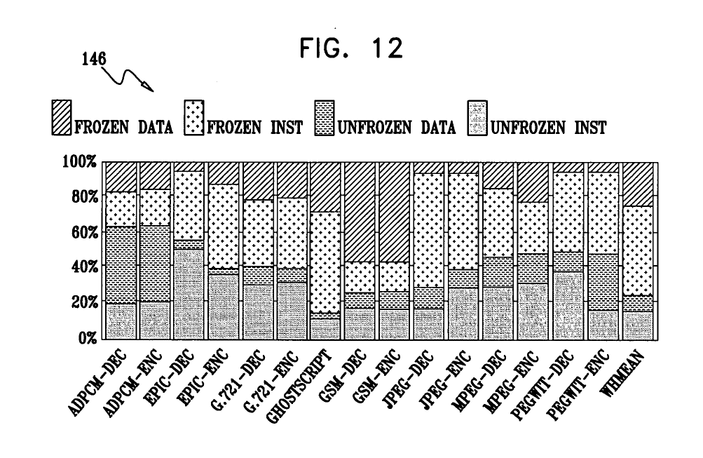

Reference is now made to FIG. 11, in which two graphs show the percentages of frozen code and data in different data sets of the CPU2000 suites, in order to quantify the quality of the training runs the amount of frozen code/data of a training set, shown in graph 142, was compared with a reference data set, shown in graph 144.

### EXAMPLE 2

The MediaBench suite, which was compiled in 1997, is described in Reference 36. Mediabench is a suite of applications for the embedded domain. The benchmarks are supplied with two datasets, one of which can be selected as a training set and the other as a reference set. Table 1 lists the inputs used for each benchmark that was used. Most of the benchmarks are composed of two executables, an encoder and decoder, and are treated as different applications.

TABLE 1

| Benchmark | mode | Train input | Ref. input |
|---|---|---|---|
| adpcm | dec | clinton.adpcm | S_16_44.adpcm |
| adpcm | enc | clinton.pcm | S_16_44.pcm |
| epic | dec | test_image.pgm.E | titanic3.pgm.E |
| epic | enc | test_image.pgm | titanic3.pgm |
| g.721 | dec | clinton.g721 | S_16_44.g721 |
| g.721 | enc | clinton.pcm | S_16_44.pcm |
| ghostscript | dec | tiger.ps | titanic2.ps |
| gsm | dec | clinton.pcm.gsm | S_16_44.pcm.gsm |
| gsm | enc | clinton.pcm | S_16_44.pcm |
| jpeg | dec | testimg.jpg | monalisa.jpg |
| jpeg | enc | testimg.ppm | monalisa.jpg |
| mpeg2 | dec | meil6v2.m2v | tek6.m2v |
| mpeg2 | enc | options.par | — |
| pegwit | dec | pegwit.dec | — |
| pegwit | enc | pegwit.enc | — |

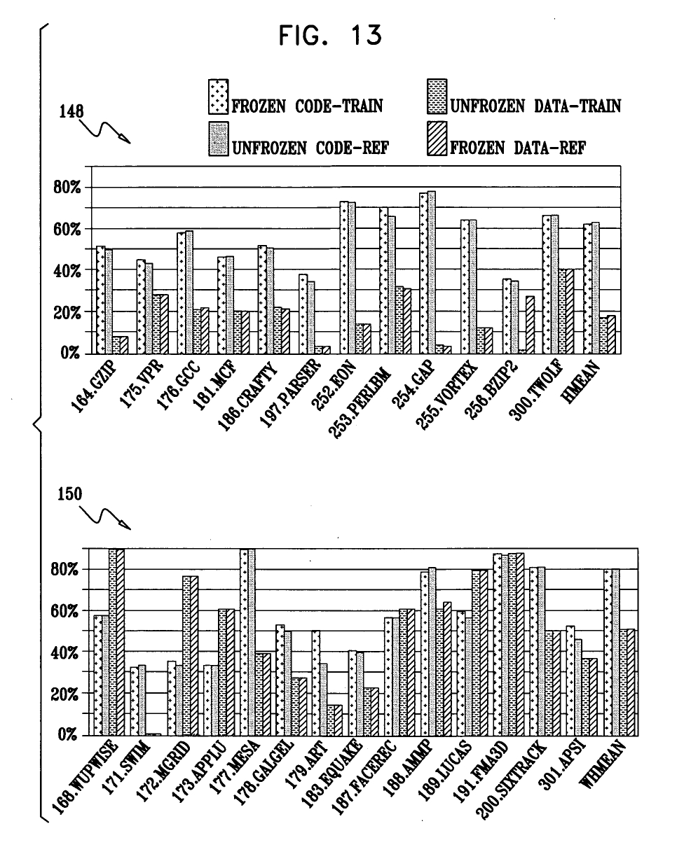

Reference is now made to FIG. 12, which is a graph 146 showing the proportions of frozen code and data in the Mediabench suite. In these applications, the ratio is 76/82%, which is even better than for the CPU2000 suites. An average reduction of 78% in the runtime image size was achieved.

In order for the inventive methods disclosed herein to work without performance degradation, it is best that frozen code and data areas are either related to error handling or infrequent case handling. In both cases, it is assumed that the code has been written in order to preserve correctness and generality of the program, even though performance will be degraded. Obviously, this will not be the case for every application. For example, the program 176.gcc of CINT2000, the gcc compiler, contains hundreds of command line flags. It is virtually impossible to devise a representative trace that can cover all valid executions.

Thus, in order to evaluate the quality of the training runs, the amount of frozen code and data in both the training and reference datasets was compared.

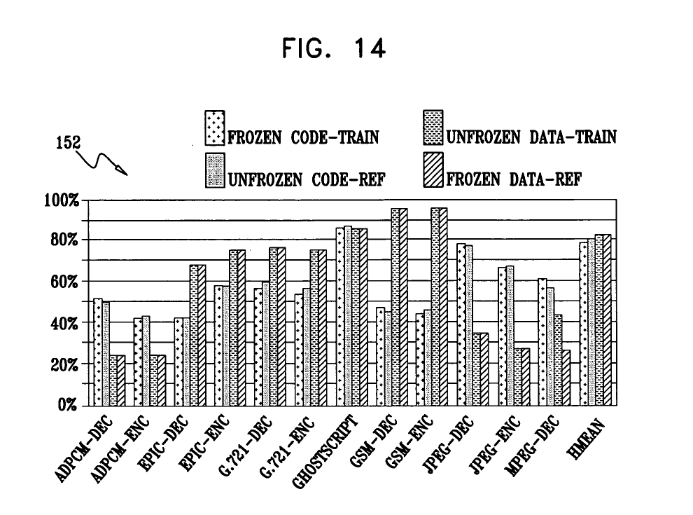

Reference is now made to FIG. 13, in which graphs 148, 150 compare the proportions of frozen code and data in the training and reference data sets of CINT2000 and CFP2000 suites of the CPU2000 series, respectively.

Reference is now made to FIG. 14, in which a graph 152 compares the proportions of frozen code and data in the training and reference data sets of the Mediabench suite.

Inspection of FIG. 13 and FIG. 14 shows that the differences are small, except for the application g.721, which displays a greater variation. However, they differences are not identical. Table 2 summarizes the average differences in size and dynamic instruction count for the training data set and reference data set, in both absolute numbers and ratios. Results for the CINT2000 suite, the CFP2000 suite and the Mediabench suite are shown.

TABLE 2

| Suite | Type | Metric | Diff. |
|---|---|---|---|
| CINT2000 | code | KB | 12 |
| | | % | 0.32 |
| | data | KB | 1 |
| | | % | 0.05 |
| CFP2000 | code | KB | 5 |
| | | % | 0.53 |
| | data | KB | 0.1 |
| | | % | 0.34 |
| MediaBench | code | KB | 0.3 |
| | | % | 0.09 |
| | data | KB | 0.05 |
| | | % | 0.08 |

The above results indicate that there are code segments that may become unfrozen under different workloads. These segments are not error correction code and, in retrospect, should not have been taken out of the loading section. Such segments are referred to as “singular mispredictions”.

The main performance penalty incurred by use of the inventive method derives from the fact that access to the disk is required for each singular misprediction. This can take up to 50 ms or more, depending on the speed of the disk and I/O bus. However, for every singular misprediction, the penalty is paid only on first encounter. Future references are replaced by corresponding branch instructions by the loading subroutine handler.

In order to learn more about the estimated penalty of the singular mispredictions, the gcc benchmark was selected as a candidate for investigation, as it contains the highest number of differences in behavior between the training and the reference sets under different workloads. Therefore, the numbers now presented represent the worst case scenario for the SPEC CPU 2000 suite, using the method according to the invention.

The actual size of the gcc code that is considered frozen with the train workload, yet turns out not to be frozen when executing the reference set, is about 4000 bytes, corresponding to about 200 basic blocks. The entire gcc code includes a total of 95,000 basic blocks. Thus, the proportion of singular mispredictions is approximately 0.2% of the basic blocks. In addition, it turns out that all singular mispredictions are considered cold, i.e., rarely executed even under the reference workload. It is concluded that the number of singular mispredictions is sufficiently small, and unlikely to cause significant overhead.

The first prototype system on which the examples were run was developed on a non-embedded system (AIX on a Power4 processor), which might not need or exploit the full potential of the system.

In order to partially test its usefulness the experiments shown in the examples above were run on a Linux system (2.6.5-7-pseries64), compiled with gcc version 3.3.3. The frozen code/data ratios were virtually the same as for the first prototype system.

This technique produced image sizes on the SPEC CINT2000, CFP2000, and MediaBench that were reduced by an average 59%, 79%, and 78%, respectively.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art, which would occur to persons skilled in the art upon reading the foregoing description.

1. A method for producing a run-time image of a computer program for execution thereof by a target computing device, comprising the steps of:
identifying frozen regions in said program that are never accessed during run-time thereof, and identifying non-frozen regions in said program that are accessed during run-time;
identifying referencing instructions of said non-frozen regions that cause respective ones of said frozen regions to be referenced by said program;
placing said frozen regions into a non-loading module;
placing said non-frozen regions into a loading module that is executable by said target computing device; and
modifying said referencing instructions, so that execution of said modified referencing instructions in said loading module by said target computing device causes said respective ones of said frozen regions to be transferred from said non-loading module into a memory that is accessible by said target computing device.

2. The method according to claim 1, wherein said step of identifying is performed by profiling dynamic behavior of said program.

3. The method according to claim 1, wherein placing said frozen regions in said non-loading module determining target offsets of said frozen regions in said non-loading module.

4. The method according to claim 1, wherein said frozen regions comprise executable code.

5. The method according to claim 1, wherein said frozen regions comprise static data.

6. The method according to claim 1, wherein said modified referencing instructions comprise invalid instructions, and said step of modifying comprises providing an error handling routine that is invoked in said target computing device responsively to said invalid instructions, wherein said error handling routine is operative to transfer one of said frozen regions from said non-loading module into said memory.

7. The method according to claim 1, further comprising the steps of providing a loading routine that is operative to dynamically allocate said memory for storage of said frozen regions that are transferred therein.

8. The method according to claim 7, wherein said loading routine operates speculatively to transfer said frozen regions from said non-loading module to said memory prior to execution of respective ones of said modified referencing instructions.

9. The method according to claim 1, wherein said steps of identifying, placing said frozen regions, and modifying are further performed with respect to cold regions in said program.

10. A computer software product, including a computer-readable medium in which instructions are stored, which instructions, when read by a computer, cause the computer to perform a method for producing a run-time image of a computer program for execution thereof by a target computing device, comprising the steps of:
identifying frozen regions in said program that are never accessed during run-time thereof, and identifying non-frozen regions in said program that are accessed during run-time;
identifying referencing instructions of said non-frozen regions that cause respective ones of said frozen regions to be referenced by said program;
placing said frozen regions into a non-loading module;
placing said non-frozen regions into a loading module that is executable by said target computing device; and
modifying said referencing instructions, so that execution of said modified referencing instructions in said loading module by said target computing device causes said respective ones of said frozen regions to be transferred from said non-loading module into a memory that is accessible by said target computing device.

11. The computer software product according to claim 10, wherein said step of identifying is performed by profiling dynamic behavior of said program.

12. The computer software product according to claim 10, wherein placing said frozen regions in said non-loading module determining target offsets of said frozen regions in said non-loading module.

13. The computer software product according to claim 10, wherein said frozen regions comprise executable code.

14. The computer software product according to claim 10, wherein said frozen regions comprise static data.

15. The computer software product according to claim 10, wherein said modified referencing instructions comprise invalid instructions, and said step of modifying comprises providing an error handling routine that is invoked in said target computing device responsively to said invalid instructions, wherein said error handling routine is operative to transfer one of said frozen regions from said non-loading module into said memory.

16. The computer software product according to claim 10, further comprising the steps of providing a loading routine that is operative to dynamically allocate said memory for storage of said frozen regions that are transferred therein.

17. The computer software product according to claim 16, wherein said loading routine operates speculatively to transfer said frozen regions from said non-loading module to said memory prior to execution of respective ones of said modified referencing instructions.

18. The computer software product according to claim 10, wherein said steps of identifying, placing said frozen regions, and modifying are further performed with respect to cold regions in said program.

19. A development system for producing a run-time image of a computer program for execution thereof by a target computing device, comprising:
a processor operative for identifying frozen regions in said program that are never accessed during run-time thereof, and identifying non-frozen regions in said program that are accessed during run-time;
said processor being operative for identifying referencing instructions of said non-frozen regions that cause respective ones of said frozen regions to be referenced by said program;
said processor being operative for placing said frozen regions into a non-loading module;
said processor being operative for placing said non-frozen regions into a loading module that is executable by said target computing device; and
said processor being operative for modifying said referencing instructions, so that execution of said modified referencing instructions in said loading module by said target computing device causes said respective ones of said frozen regions to be transferred from said non-loading module into a memory that is accessible by said target computing device.

20. The development system according to claim 19, wherein said processor is operative for profiling dynamic behavior of said program to identify said frozen regions and said non-frozen regions.

21. The development system according to claim 19, wherein placing said frozen regions in said non-loading module determining target offsets of said frozen regions in said non-loading module.

22. The development system according to claim 19, wherein said frozen regions comprise executable code.

23. The development system according to claim 19, wherein said frozen regions comprise static data.

24. The development system according to claim 19, wherein said modified referencing instructions comprise invalid instructions, and said processor is operative to provide an error handling routine that is invoked responsively to said invalid instructions, wherein said error handling routine is operative to transfer one of said frozen regions from said non-loadable module into said memory.

25. The development system according to claim 19, wherein said processor is operative to provide a loading routine for dynamically allocating said memory to accept said frozen regions being transferred from said non-loading module for storage therein.

26. The development system according to claim 25, wherein said loading routine operates speculatively to transfer said frozen regions from said non-loading module to said memory prior to execution of respective ones of said modified referencing instructions.

27. The development system according to claim 19, wherein said processor is further adapted to identify cold regions in said program, place said cold regions in said non-loading module, and modify instructions of said loading module with respect to said cold regions to produce additional modified instructions, which additional modified instructions, when executed by said target computing device cause respective ones of said cold regions to be transferred from said non-loading module into said memory of said target computing device.
